(19) United States
(12) Patent Application Publication
(10) Pub. No.: US 2013/0345380 A1
(43) Pub. Date: Dec. 26, 2013

(54) NOVEL INITIATION PROCESS FOR POLYMERIZATION WITH ACTIVATION USING IONIC LIQUIDS

(71) Applicants: Friedrich Georg Schmidt, Haltern am See (DE); Stefan Spange, Orlamuende (DE); Ingmar Polenz, Goettingen (DE); Ralf Lungwitz, Chemnitz (DE)

(72) Inventors: Friedrich Georg Schmidt, Haltern am See (DE); Stefan Spange, Orlamuende (DE); Ingmar Polenz, Goettingen (DE); Ralf Lungwitz, Chemnitz (DE)

(73) Assignee: Evonik Degussa GmbH, Essen (DE)

(21) Appl. No.: 14/004,170

(22) PCT Filed: Mar. 7, 2012
(86) PCT No.: PCT/EP2012/053829

§ 371 Date: Sep. 10, 2013

(30) Foreign Application Priority Data
Apr. 15, 2011 (DE) 10 2011 007 514.3

(51) Int. Cl. C08F 120/14

(52) U.S. Cl. CPC C08F 120/14
USPC 526/193; 526/329.7; 526/220; 526/204; 526/205

(57) ABSTRACT

The present invention relates to an innovative polymerization technique for (meth)acrylates and styrenes, in which the polymerization is initiated by isocyanates and special bases with imine structure and is activated/accelerated by addition of ionic liquids. With this new technique, which can be employed selectively, it is also possible to produce high molecular weight poly(meth)acrylates with in some cases narrow molecular weight distribution.

The (meth)acrylate notation here denotes not only methacrylate, such as methyl methacrylate, ethyl methacrylate, etc., but also acrylate, such as methyl acrylate, ethyl acrylate, etc., for example, and also mixtures of both.

### FIELD OF THE INVENTION

The present invention relates to an innovative polymerization technique for (meth)acrylates and styrenes, in which the polymerization is initiated by isocyanates and special bases with imine structure and is activated and/or accelerated by addition of ionic liquids. With this new technique, which can be employed selectively, it is also possible to produce high molecular weight poly(meth)acrylates with in some cases narrow molecular weight distribution.

The (meth)acrylate notation here denotes not only methacrylate, such as methyl methacrylate, ethyl methacrylate, etc., but also acrylate, such as methyl acrylate, ethyl acrylate, etc., for example, and also mixtures of both.

### PRIOR ART

For the polymerization of (meth)acrylates there are a range of polymerization techniques known. Free-radical polymerization in particular is of decisive significance industrially. In the form of bulk, solution, emulsion, or suspension polymerization, it is very commonly used for the synthesis of poly(meth)acrylates for any of a very wide variety of applications. These include molding compounds, Plexiglas, film-forming binders, additives, or components in adhesives or sealants, to recite only a few. Disadvantages of free-radical polymerization, however, are that no influence can be exerted at all on the polymer architecture, that functionalization is possible only with very low specificity, and that the polymers are produced with broad molecular weight distributions.

In order to take account of these disadvantages, a variety of controlled polymerization techniques have been developed for (meth)acrylates and styrenes. Besides anionic polymerization and living radical polymerization techniques, such as NMP, RAFT, and ATRP, an initiation with strong bases having imide structure and isocyanates has been described in German patent application 102009055061.5. Depending on the base-isocyanate combination, however, this technique requires very different activation temperatures. In this respect, accordingly, there is a need for improvement in relation to a more flexible design of this initiation technique.

### PROBLEM

A problem addressed by the present invention is that of providing a new polymerization technique for the polymerization of (meth)acrylates and/or styrenes that can be carried out with only one initiator component.

A problem addressed by the present invention more particularly is that of developing the polymerization technique described in DE 102009055061.5 for the polymerization of (meth)acrylates and/or styrenes.

A problem addressed, furthermore, is that of making this polymerization technique more flexible in respect of the initiation temperature and/or the overall reaction rate. This relates, for example, to the lowering of the initiation temperature of the combinations of a base and an isocyanate, which require relatively high initiation temperatures.

A further problem addressed is that of improving the yields of the polymerization initiated by means of bases and isocyanate.

Further problems addressed, but not explicitly stated, will become apparent from the overall context of the following description, claims, and examples.

### SOLUTION

The problems addressed have been solved by a very surprisingly found, new initiation mechanism, with which a polymerization of vinylic monomers M can be initiated. By vinylic monomers M in this context are meant monomers which have a carbon-carbon double bond. Generally speaking, such monomers can be polymerized radically and/or anionically. In this new method, the polymerization of the monomers M is initiated by the presence of an optional component A, a component B, and a component C. Component A is an isocyanate or a carbodiimide. Component B is an organic base. Component C is an ionic liquid.

The method of the invention for initiating the polymerization of vinylic monomers can be carried out in a first embodiment exclusively with component B, the base, and component C, the ionic liquid.

In a second, even more active embodiment, the method of the invention may be carried out additionally with component A, an isocyanate.

For this second embodiment, a particular feature of the method of the invention is that component A and component B are added separately from one another to the monomer M. In this case there are two preferred methods for implementing the initiation. In one, component B is added to a mixture of component A and the vinylic monomer M. In the other, conversely, component A is added for the purpose of initiation to a mixture of component B and the vinylic monomer M.

Component C in this case may be introduced initially with one component, added with the other component, or not only partly introduced initially but also partly added. With preference component C is introduced initially in its entirety either with the monomers M and the component A or the component B. The other component in each case is then added separately in order to initiate the reaction.

A particular feature of the present method is that the initiation takes place at a temperature below 50° C., depending on the combination of components A, B, and C.

A particular feature of the present invention is that through the additional component C it is possible to bring about acceleration of initiation, or initiation at a lower temperature, or a combination of a temperature reduction and an acceleration, relative to an analogous system without component C.

Component B is preferably a tertiary organic base, more preferably an organic base which has a carbon-nitrogen double bond, or alternatively a trithiocarbonate.

Suitable more particularly for use in the initiation method of the invention are bases having the following functional groups: imines, oxazolines, isoxazolones, thiazolines, amidines, guanidines, carbodiimides, pyrazoles, imidazoles, or trithiocarbonates.

By imines are meant compounds which have a (Rx)(Ry)C═N(Rz) group. In this case the two groups on the carbon atom, Rx and Ry, and the one group on the nitrogen atom, Rz, are freely selectable, are identical to or different from one another, and may also form one or more ring systems. Examples of such imines are 2-methylpyrroline (1), N-benzylidenemethylamine (BMA, (2)), or N-4-methoxybenzylideneaniline (3).

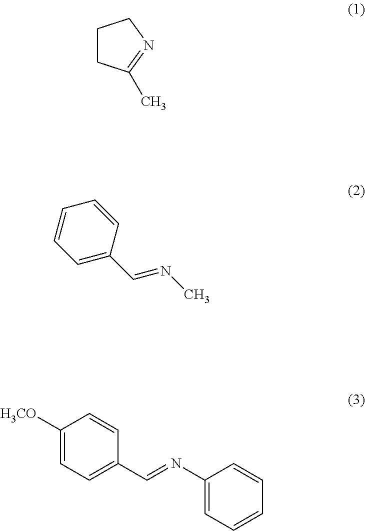

Oxazolines are compounds which have a (Ry)O—C(Rx)=N(Rz) group. With these compounds as well, the groups on the carbon atom, Rx, on the oxygen, Ry, and on the nitrogen atom, Rz, are in each case freely selectable, identical to or different from one another, and may also form one or more ring systems. Examples of oxazolines are 2-ethyloxazoline (4) and 2-phenyloxazoline (POX, 5):

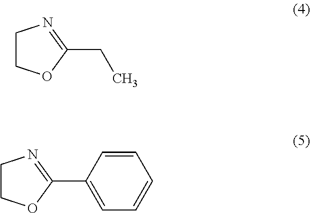

Isoxazolones are compounds having the structural element (6):

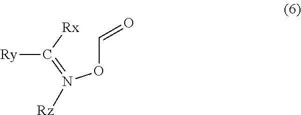

For the two groups on the carbon atom, Rx and Ry, and the one group on the nitrogen atom, Rz, it is also the case for the isoxazolones that these groups can be freely selectable and may be identical to or different from one another. It is also possible for them to form one or more ring systems. One example of an isoxazolone of this kind is 3-phenyl-5-isoxazolone (7):

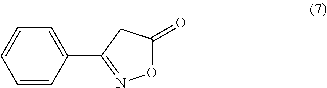 [SMILES: O=C1CC(c2ccccc2)=NO1]

Thiazolines are compounds having the structural element (8) or (9):

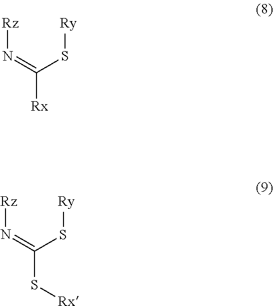

For the groups on the carbon atom, Rx, on the sulfur atom, Ry, on the second sulfur atom, Rx′, and on the nitrogen atom, Rz, it is the case that they can be freely selectable and may be identical to or different from one another. It is also possible for them to form one or more ring systems. Examples of such thiazolines are 2-methylthiazoline (10) or 2-methylmercaptothiazoline (MMT, 11):

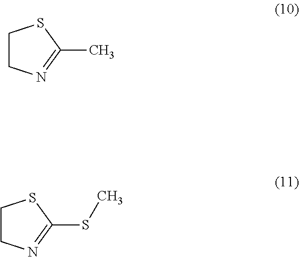

Amidines are compounds having the structural element (12); guanidines are compounds having the structural element (13):

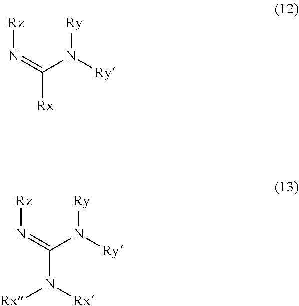

For the groups on the carbon atom, Rx, on the nitrogen atom, Rz, on the second nitrogen atom, Ry and Ry′, and on the third nitrogen atom, Rx′ and Rx″, it is the case that they can be freely selectable and may be identical to or different from one another. It is also possible for them to form one or more ring systems. Examples of amidines are 1,8-diazabicyclo[5.4.0]undec-7-ene (DBU, (14)), 1,5-diazabicyclo[4.3.0]non-5-ene (DBN, (15)), or N-(3-triethoxysilylpropyl)-4,5-dihydro-imidazole (PDHI, (16)):

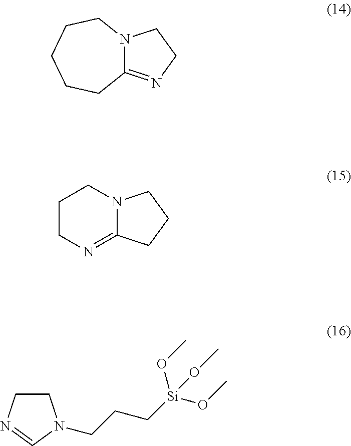

Examples of the guanidines are 7-methyl-1,5,7-triaza-bicyclo[4.4.0]dec-5-ene (MTBD, (17)), 1,1,3,3-tetramethylguanidine (TMG, (18)), or N-tert-butyl-1,1,3,3-tetramethylguanidine (19):

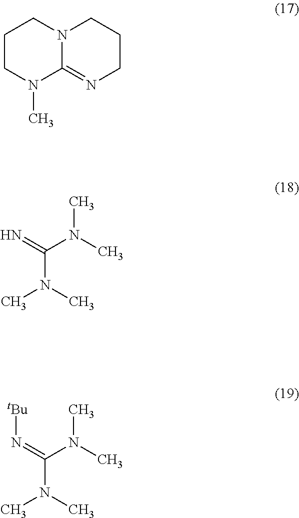

The group of the carbodiimides comprises compounds having a structural element (Rz)-N═C═N-(Rz′). For the groups on the nitrogen atoms, Rz and Rz′, it is the case that they can be freely selectable and may be identical to or different from one another. It is also possible for them to form one or more ring systems. One example of carbodiimides is diisopropylcarbodiimide (20):

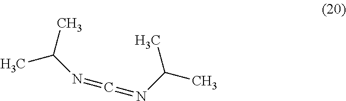

Compounds employable additionally may be imidazole (21) or 1-methylimidazole (22):

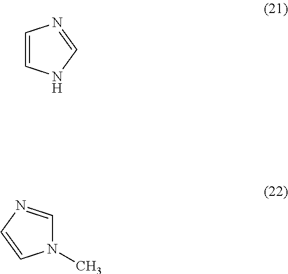

Examples of organic bases that may be used, without a C═N bond, are trithiocarbonates having the structural element (23):

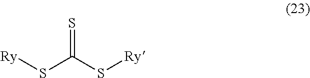

For the groups on the two sulfur atoms, Ry and Ry′, it is the case that they can be freely selectable and may be identical to or different from one another. It is also possible for them to form one or more ring systems. One example of trithiocarbonates is ethylidene trithiocarbonate (24):

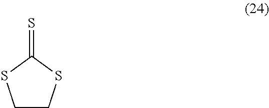

The examples of the organic bases are not in any way such as to restrict the invention in any form whatsoever. They serve, instead, to illustrate the multiplicity of compounds which may be employed in accordance with the invention.

Component A comprises isocyanates, which may be singly, doubly, or multiply functionalized. The wording isocyanate also comprises, below, the chemically equivalent thioisocyanates.

The other functionalities may in one embodiment be a second isocyanate group or further isocyanate groups. In another embodiment it is also possible for the further functionalities to be different functionalities which together with isocyanate groups form stable compounds.

Examples of monofunctional isocyanates are cyclohexyl isocyanate (25), phenyl isocyanate (26), and tert-butyl isocyanate (27). An example of a monofunctional thioisocyanate is phenyl thioisocyanate (28):

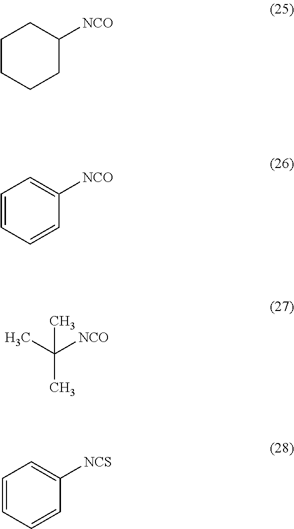

Examples of bifunctional isocyanates having two isocyanate groups are 1,6-hexamethylene diisocyanate (HDI, (29)), toluene diisocyanate (TDI, (30)), and isophorone diisocyanate (IPDI, (31)):

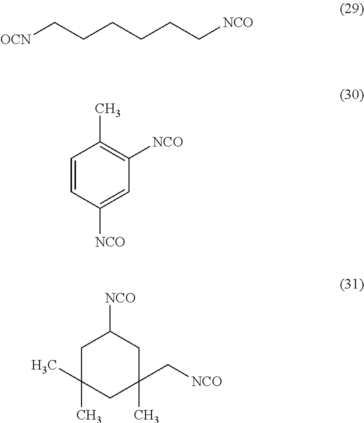

Further examples are condensates of these bifunctional isocyanates, especially trimers of the isocyanates having two isocyanate groups, such as the HDI trimer (32) or the IPDI trimer (33):

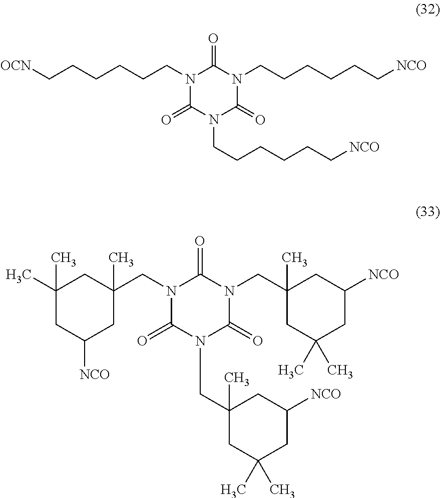

It is also possible, furthermore, for monofunctional, linear isocyanates to be used, such as dodecyl isocyanate (34) or ethyl isocyanate (35):

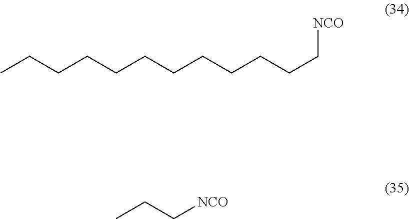

Alternatively to the isocyanates it is also possible to use carbodiimides. These are compounds having the structural element (Rz)-N═C═N-(Rz′) in accordance with the structure already outlined, as set out for the organic bases that can be used. One example of a carbodiimide which can be used instead of isocyanates is diisopropylcarbodiimide (20):

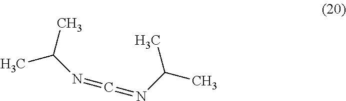

In one particular embodiment of the invention, using carbodiimides, it is possible for both components A and B to be identical. In this embodiment it is also not necessary for one of the two components to be added to the system with a time delay, and so in this exceptional embodiment a one-component initiator system is present.

In an alternative embodiment it is also possible for an adduct to be formed first from the two components of isocyanate and organic base, and for this adduct per se, in turn, to initiate a polymerization. These intermediates can also be isolated, and so may be employed as alternative initiators. One example of such an adduct is the reaction product (36) of two molecules of TMG (18) and HDI (29):

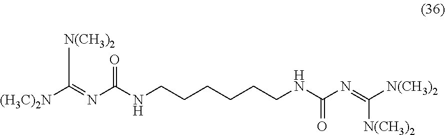

Component C is a liquid which below 100° C. under atmospheric pressure is present in the form of a liquid substance and is composed of at least one cation and at least one anion. More particularly, component C is a substance known generally to the skilled worker under the designation of an ionic liquid.

The cation here is preferably an imidazolium, a pyridinium, a pyrrolidinium, a guanidinium, a uronium, a thiouronium, a piperidinium, a morpholinium, an ammonium, or a phosphonium. The anion is preferably a halide, a borate, such as tetrafluoroborate, a trifluoroacetate, a triflate, a phosphate, such as hexafluorophosphate, a phosphinate, a nitrate, a tosylate, an imide, or an amide.

Particularly preferred ionic liquids are compounds having a 1-alkyl-3-methylimidazolium cation (mim), more particularly having an ethyl (Emim), butyl (Bmim), or decyl (C₁₀mim) radical. Likewise preferred are pyridinium cations, such as N-hexylpyridinium (Pyhex), phosphonium cations, more particularly methyltributyl-phosphonium (MePBu₃), or ammonium cations, more particularly methyltributylammonium (MeNBu₃), for example.

Particularly preferred anions are bis(trifluoromethyl-sulfonyl)imide (Ntf₂), hexafluorophosphate (PF₆), tetrafluoroborate (BF₄), tetraphenylborate (BPh₄), tris(perfluoroethyl)trifluorophosphate (FAP), or nitrate (NO₃). Specific examples of ionic liquids are C₁₀mimNO₂ (37), BmimNtf₂ (38), BmimPF₆ (39), EmimFAP (40), MeNBu₃Ntf₂ (41), MePBu₃Ntf₂ (42), and PyhexNtf₂ (43).

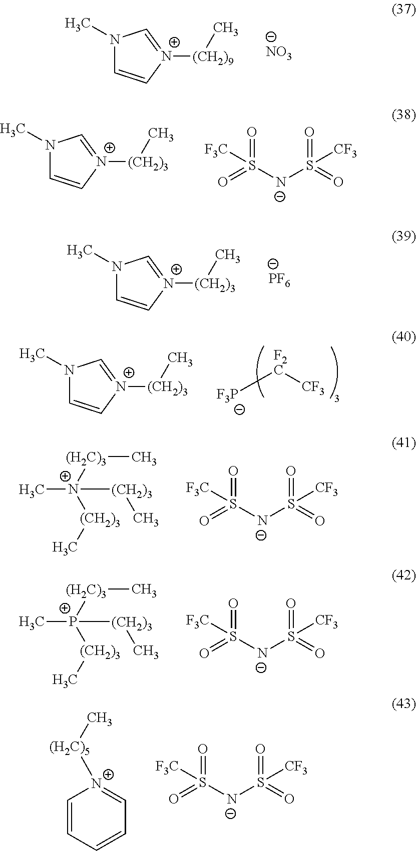

The method of the invention for initiating a polymerization is in principle independent of the polymerization process used. The method for initiation and the subsequent polymerization may be carried out, for example, in the form of a solution polymerization or bulk polymerization. The polymerization may be carried out in batch mode or continuously. The polymerization, furthermore, may be carried out over the entire customary temperature spectrum and under superatmospheric, atmospheric, or subatmospheric pressure.

One particular aspect of the present invention is that the polymers obtained from the method are produced in a very broad molecular weight range. In accordance with the GPC measurement against the polystyrene standard, these polymers may have a molecular weight of between 1000 and 10 000 000 g/mol, more particularly between 5000 and 5 000 000 g/mol, and very particularly between 10 000 and 2 000 000 g/mol.

The vinylic monomers M are monomers which have a double bond, more particularly monomers with double bonds which are polymerizable radically and/or anionically. More particularly these monomers are acrylates, methacrylates, styrene, styrene-derived monomers, α-olefins, or mixtures of these monomers.

The (meth)acrylate notation stands below for alkyl esters of acrylic acid and/or methacrylic acid. In particular the monomers are selected from the group of alkyl(meth)acrylates of straight-chain, branched or cycloaliphatic alcohols having 1 to 40 C atoms.

The polymers produced in accordance with the innovative method may find use in numerous fields of application. Without these examples restricting the invention in any form whatsoever, such fields include acrylic glass, molding compounds, raw materials for other injection-molding or extrusion applications, films, including reflective films, packaging films, films for optical applications, laminates, laminate adhesives, foams, sealing foams, foamed materials for packaging, manmade fibers, composite materials, film-forming binders, coatings additives such as dispersing additives or particles for scratch-resistant coatings, primers, binders for adhesives, hotmelt adhesives, pressure-sensitive adhesives, reactive adhesives, or sealants, heat-sealing varnishes, packaging materials, dental materials, bone cement, contact lenses, spectacle lenses, other lenses, in industrial applications, for example, traffic markings, floor coatings, plastisols, underbody coatings or insulation systems for vehicles, insulating materials, materials for use in pharmacy, drug delivery matrices, oil additives such as flow improvers, polymer additives such as impact modifiers, compatibilizers, or flow improvers, fiber spinning additives, particles in cosmetic applications, or as raw material for producing porous shapes.

### EXAMPLES

The weight-average molecular weights of the polymers were determined by means of GPC (gel permeation chromatography). The measurements were carried out with a PL-GPC 50 Plus from Polymer Laboratories Inc. at 40° C. in THF against a polystyrene standard.

The molar weight distribution (polymolecularity index, PDI) was calculated in each case as the ratio of the weight-average molecular weight to the number-average molecular weight.

The yields were determined by weighing the isolated polymer after drying to constant weight in a vacuum drying cabinet at 60° C. and 20 mbar.

### General Procedural Instructions for Examples 1 to 12

In a 25 mL round-bottom flask, under an argon atmosphere, the ionic liquids (type and amount: see tab. 1) are dissolved in 2 ml of dry THF, and then 0.545 mL (0.61 g, 4.2 mmol) of 2-phenyl-2-oxazoline (POX) is added to the solution. Also added to the reaction mixture are 2.65 mL (2.5 g, 25 mmol) of MMA, and this mixture is heated to reaction temperature (see tab. 1). After the corresponding times, NMR samples are taken in an argon gas countercurrent, for determination of the conversion by NMR spectroscopy. With increasing reaction (after about 6 to 8 hours), a severe solidification of flow is observed, and the reaction is discontinued. The reaction mixture is cooled, diluted with 10 mL of THF, and added cautiously, with stirring, to 300 mL of cold methanol. The white PMMA precipitated is isolated by filtration, washed with a little cold methanol, and dried to constant mass in a drying cabinet (100 mbar, 55° C.). For results, see table 1.

### Examples 13 to 15

These examples were carried out in analogy to examples 1 to 12. In this case, however, instead of POX, 2-methylmercaptothiazoline (MMT, 11) was used as base, in a concentration of 4.2 mmol.

### Examples 16 to 20

These examples were carried out in analogy to examples 1 to 12. In this case, however, as well as 4.2 mmol of POX, additionally 4.2 mmol of phenyl isocyanate (PIC, 26) were used as base. This was added to the reaction solution directly prior to heating, after the other components.

### Examples 21 to 24

These examples were carried out in analogy to examples 16 to 18. In this case, however, instead of phenyl isocyanate (PIC, 26), 4.2 mmol of 1,6-hexamethylene diisocyanate (HDI, 29) were used as isocyanate. The isocyanate was added to the reaction solution directly prior to heating, after the other components.

### Examples 25 to 30

These examples were carried out in analogy to examples 16 to 20. In this case, however, instead of POX, 2-methylmercaptothiazoline (MMT, 11) was used as base. The isocyanate was added to the reaction solution directly prior to heating, after the other components.

### Examples 31 to 33

These examples were carried out in analogy to examples 16 to 20. In this case, however, instead of POX, N-methylpyrazole was used as base. The isocyanate was added to the reaction solution directly prior to heating, after the other components.

TABLE 1

| | | Con- | | | | | |
|---|---|---|---|---|---|---|---|
| | Ionic | centration | t | T | | | |
| Ex. | liquid | [mol/L] | [h] | [° C.] | Mₙ | PDI | Yield |
| 1 | (40) | 0.041 | 18 | 65 | 72 400 | 1.87 | 61% |
| 2 | (40) | 0.071 | 20 | 65 | 110 400 | 1.95 | 56% |
| 3 | (40) | 0.107 | 16 | 65 | 90 200 | 1.96 | 55% |
| 4 | (40) | 0.043 | 8.4 | 84 | 67 200 | 1.60 | 67% |
| 5 | (40) | 0.044 | 5.8 | 73 | 167 800 | 1.93 | 47% |
| 6 | (40) | 0.043 | 10 | 97 | 34 500 | 1.33 | 78% |
| 7 | (38) | 0.045 | 19 | 84 | 56 500 | 1.70 | 99% |
| 8 | (39) | 0.069 | 16 | 84 | 60 000 | 1.79 | 99% |
| 9 | (37) | 0.067 | 2.3 | 84 | 54 800 | 1.52 | 66% |
| 10 | (42) | 0.042 | 7 | 85 | 54 400 | 1.81 | 46% |
| 11 | (41) | 0.063 | 5 | 85 | 333 100 | 2.06 | 19% |
| 12 | (43) | 0.061 | 4.5 | 85 | 266 800 | 1.78 | 30% |
| 13 | (40) | 0.043 | 2.5 | 65 | 46 700 | 1.54 | 15% |
| 14 | (40) | 0.044 | 3.7 | 83 | 58 100 | 1.58 | 49% |
| 15 | (40) | 0.046 | 2.9 | 95 | 139 000 | 1.85 | 40% |
| 16 | (41) | 0.051 | 35 | 23 | 59 800 | 1.75 | 55% |
| 17 | (42) | 0.058 | 35 | 23 | 66 700 | 1.78 | 51% |
| 18 | (43) | 0.067 | 35 | 23 | 65 000 | 1.96 | 42% |
| 19 | (38) | 0.730 | 25 | 132 | 446 400 | 1.62 | 29% |
| 20 | (40) | 0.050 | 25 | 34 | 50 900 | 1.53 | 72% |
| 21 | (40) | 0.042 | 70 | 12 | n.d. | n.d. | 75% |
| 22 | (42) | 0.040 | 25 | 72 | 204 500 | 1.86 | 29% |
| 23 | HexPyNtf₂ | 0.040 | 25 | 72 | 334 300 | 1.72 | 30% |
| 24 | (41) | 0.040 | 25 | 72 | 336 900 | 1.83 | 20% |
| 25 | (40) | 0.110 | 25 | 21 | 125 600 | 1.91 | 39% |
| 26 | (40) | 0.110 | 25 | 70 | 82 000 | 2.02 | 70% |
| 27 | (40) | 0.050 | 50 | 21 | 42 600 | 1.68 | 90% |
| 28 | (40) | 0.050 | 60 | 25 | 38 700 | 1.44 | 70% |
| 29 | (40) | 0.050 | 70 | 4.5 | 69 700 | 1.69 | 36% |
| 30 | (40) | 0.050 | 70 | 9.7 | 79 600 | 1.59 | 65% |
| 31 | (40) | 0.210 | 25 | 40 | 57 900 | 1.55 | 63% |
| 32 | (40) | 0.210 | 25 | 72 | 46 900 | 1.71 | 82% |
| 33 | (40) | 0.210 | 55 | 12 | 32 200 | 1.81 | 35% |

Comparative examples relative to examples 16 to 30, for the initiator system with base and isocyanate, are found in German patent application DE 102009055061.5. It is readily apparent that by adding the ionic liquids it is possible alternatively to lower the reaction temperature, to down to room temperature; to raise the yield; or to shorten the reaction time. It is also possible to obtain combinations of these three effects.

1. A method for initiating polymerization, comprising initiating
polymerization of a vinylic monomer M with a component B and a component C,
wherein the component B is an organic base,
and the component C is an ionic liquid.

2. The method of claim 1, wherein
the initiating further comprises adding a component A, which is an isocyanate or a carbodiimide, additionally to the mixture, and
component A and component B are added separately from one another to the monomer M.

3. The method of claim 2, wherein the initiating comprises adding component B to a mixture of component A, the ionic liquid C, and a vinylic monomer M.

4. The method of claim 2, wherein the initiating comprises adding component A to a mixture of component B, the ionic liquid C, and a vinylic monomer M.

5. The method of claim 1, wherein the initiating is performed at a temperature below 50° C.

6. The method of claim 2, wherein the component A is dodecyl isocyanate, ethyl isocyanate, 1,6-hexa-methylene diisocyanate (HDI), an HDI trimer, cyclohexyl isocyanate, tert-butyl isocyanate, phenyl isocyanate, toluene diisocyanate (TDI), isophorone diisocyanate (IPDI), or an IPDI trimer.

7. The method of claim 1, wherein the component C is a substance which is liquid below 100° C. and is composed of a cation and an anion.

8. The method of claim 7, wherein the cation is an imidazolium, a pyridinium, a pyrrolidinium, a guanidinium, a uronium, a thiouronium, a piperidinium, a morpholinium, an ammonium, or a phosphonium, and in that the anion is a halide, a nitrate, a borate, preferably tetrafluoroborate or tetraphenylborate, a trifluoroacetate, a triflate, a phosphate, preferably hexafluorophosphate or tris(perfluoro-ethyl)trifluorophosphate, a phosphinate, a tosylate, an imide, or an amide.

9. The method of claim 1, wherein the component B is a tertiary organic base or a trithiocarbonate.

10. The method of claim 9, wherein the base is an imine, an oxazoline, a carbodiimide, an isoxazolone, a thiazoline, an amidine, a pyrazole, a guanidine, or an imidazole.

11. The method of claim 2, wherein the component A is an isocyanate, and the isocyanate is a bifunctional isocyanate.

12. The method of claim 6, wherein a polymer obtained, in a GPC measurement against a polystyrene standard, has a weight-average molecular weight of between 5000 and 10 000 000 g/mol.

13. The method of claim 1, wherein the vinylic monomer M is an acrylate, methacrylate, styrene, styrene-derived monomer, α olefin, or a mixture thereof.

14. The method of claim 8, wherein the cation is an imide, and the imide is bis(trifluoro-methylsulfonyl)imide.

15. The method of claim 9, wherein the component B is a tertiary organic base, and the tertiary organic base is an organic base having a carbon-nitrogen double bond.
